(19) United States
(12) Patent Application Publication
(10) Pub. No.: US 2019/0155303 A1
(43) Pub. Date: May 23, 2019

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Koji Kawabe, Wako-shi (JP); Hiroshi Miura, Wako-shi (JP); Makoto Ishikawa, Wako-shi (JP); Masamitsu Tsuchiya, Wako-shi (JP)

(21) Appl. No.: 16/186,633

(22) Filed: Nov. 12, 2018

(30) Foreign Application Priority Data
Nov. 17, 2017 (JP) 2017-222083

(51) Int. Cl. G05D 1/02; G06N 5/02; G05D 1/00

(52) U.S. Cl. CPC G05D 1/0255; G05D 2201/0213; G05D 1/0088; G06N 5/02

(57) ABSTRACT

A vehicle control device includes a measurement unit measuring a vibration of a subject vehicle and a prediction unit predicting the presence of a predetermined place, at which a control state of the subject vehicle is to be changed, in front of the subject vehicle in an advancement direction on the basis of a degree of coincidence between a trend of vibrations measured by the measurement unit and a vibration trend of a vehicle measured in advance.

### CROSS-REFERENCE TO RELATED APPLICATION

This application is based upon and claims the benefit of priority from Japanese Patent Application No. 2017-222083, filed Nov. 17, 2017, the entire contents of which are incorporated herein by reference.

### BACKGROUND

### Field of the Invention

The present invention relates to a vehicle control device, a vehicle control method, and a storage medium.

### Description of Related Art

In recent years, research on automated driving has progressed. In relation with this, a technology is known for recognizing a driving environment by acquiring a distance or a direction with respect to a preceding vehicle or a still object ahead of a vehicle from a result of detection executed by a radar mounted in a vehicle, further acquiring an intersection disposed ahead of the vehicle from a road map in which a vehicle position on a road map detected by a Global Positioning System (GPS) device is associated, and estimating positions of a driving lane, a preceding vehicle, a still object, a traffic lamp, a crosswalk, and the like inside an image captured by an imaging device on the basis of such acquired information (for example, see Japanese Patent Application Publication No. 2004-265432).

### SUMMARY

However, in the conventional technology, there are cases in which the accuracy of recognition of the position of a subject vehicle on a map is decreased in a situation in which the number of objects recognized by various sensors such as a radar and the like is small. As a result, there are cases in which there is a section in which automated driving cannot be executed.

An aspect of the present invention is realized in consideration of such situations, and one object thereof is to provide a vehicle control device, a vehicle control method, and a storage medium capable of executing automated driving in more sections.

A vehicle control device, a vehicle control method, and a storage medium according to the present invention employ the following configurations.

According to one aspect (1) of the present invention, a vehicle control device is provided, including: a measurement unit measuring vibration of a subject vehicle; and a prediction unit predicting the presence of a predetermined place at which a control state of the subject vehicle is to be changed in front of the subject vehicle in an advancement direction on the basis of a degree of coincidence between a trend of vibration measured by the measurement unit and a vibration trend of a vehicle measured in advance.

According to an aspect (2), in the vehicle control device according to the aspect (1), the prediction unit predicts a fixed place of which a relative position with respect to a vehicle is not changed as the predetermined place.

According to an aspect (3), the vehicle control device according to the aspect (1) further includes: a recognizer recognizing ground objects in the vicinity of the subject vehicle; and a storage unit storing a map including positional information of ground objects that are recognizable for the recognizer, and, in a case in which the number of ground objects present in front of the subject vehicle in the advancement direction on the map stored by the storage unit is less than a predetermined number, the prediction unit starts a process of predicting the presence of the predetermined place.

According to an aspect (4), the vehicle control device according to the aspect (3) further includes a driving controller that controls one or both of steering and acceleration/deceleration of the subject vehicle on the basis of a result of the prediction executed by the prediction unit in a case in which the number of ground objects present in front of the subject vehicle in the advancement direction among one or more ground objects with which positions are associated on the map is less than a predetermined number and controls one or both of the steering and the acceleration/deceleration of the subject vehicle on the basis of the ground objects recognized by the recognizer in a case in which the number of the ground objects is equal to or greater than the predetermined number.

According to an aspect (5), the vehicle control device according to the aspect (1) further includes an acceptor that accepts an operation of a vehicle occupant of the subject vehicle; and a storage controller that stores information associating a trend of vibration measured by the measurement unit with a route along which the subject vehicle runs in a predetermined storage unit in a case in which a predetermined operation is accepted by the acceptor, and the prediction unit selects information representing a trend of vibration of the subject vehicle acquired when the subject vehicle run along a target route along which the subject vehicle is currently running, in the past among one or more pieces of information stored in the storage unit and predicts the presence of the predetermined place in front of the subject vehicle in the advancement direction on the basis of the trend of the vibrations represented by the selected information and a trend of vibration measured by the measurement unit while the vehicle is running along the target route.

According to another aspect (6) of the present invention, a vehicle control method is provided, including: measuring vibration of a subject vehicle using a measurement unit; and predicting the presence of a predetermined place at which a control state of the subject vehicle is to be changed in front of the subject vehicle in an advancement direction on the basis of a degree of coincidence between a trend of vibration measured by the measurement unit and a vibration trend of a vehicle measured in advance using a prediction unit.

According to another aspect (7) of the present invention, a storage medium is provided storing a program thereon, the program causing a computer, which is mounted in a vehicle including a measurement unit measuring vibration of a subject vehicle, to execute: predicting the presence of a predetermined place at which a control state of the subject vehicle is to be changed in front of the subject vehicle in an advancement direction on the basis of a degree of coincidence between a trend of vibration measured by the measurement unit and a vibration trend of a vehicle measured in advance.

According to any one of the aspects (1) to (7), automated driving can be executed in more sections.

### BRIEF DESCRIPTION OF THE DRAWINGS

FIG. 1 is a configuration diagram of a vehicle system using a vehicle control device according to a first embodiment;

FIG. 2 is a diagram showing one example of vibration information for individual routes;

FIG. 3 is a diagram showing one example of vibration data.

FIG. 4 is a functional configuration diagram of a first controller and a second controller;

FIG. 5 is a diagram showing a view in which a target locus is generated on the basis of a recommended lane;

FIG. 6 is a diagram showing one example of a view in which no ground object is present;

FIG. 7 is a flowchart showing one example of a process executed by an automated driving control device according to the first embodiment;

FIG. 8 is a diagram showing a method of estimating a position of a subject vehicle on the basis of vibration data;

FIG. 9 is a diagram showing one example of a method of setting a target speed when a predetermined place is present;

FIG. 10 is a diagram showing another example of a method of setting a target speed when a predetermined place is present;

FIG. 11 is a configuration diagram of a vehicle system using a vehicle control device according to a second embodiment;

FIG. 12 is a flowchart showing one example of a process executed by a storage controller;

FIG. 13 is a diagram schematically illustrating a view in which vibration data of a subject vehicle is accumulated; and

FIG. 14 is a diagram showing one example of the hardware configuration of an automated driving control device according to an embodiment.

### DESCRIPTION OF EMBODIMENTS

Hereinafter, a vehicle control device, a vehicle control method, and a storage medium according to embodiments of the present invention will be described with reference to the drawings. In the following embodiments, the vehicle control device will be described when applied to a vehicle capable of performing automated driving (autonomous driving). Automated driving, for example, is an aspect for causing a vehicle to run by controlling one or both of steering and acceleration/deceleration of the vehicle without depending on an operation of a vehicle occupant of the vehicle. In automated driving, driving support such as adaptive cruise control (ACC) or lane keeping assist (LKAS) may be included.

### First Embodiment

### Entire Configuration

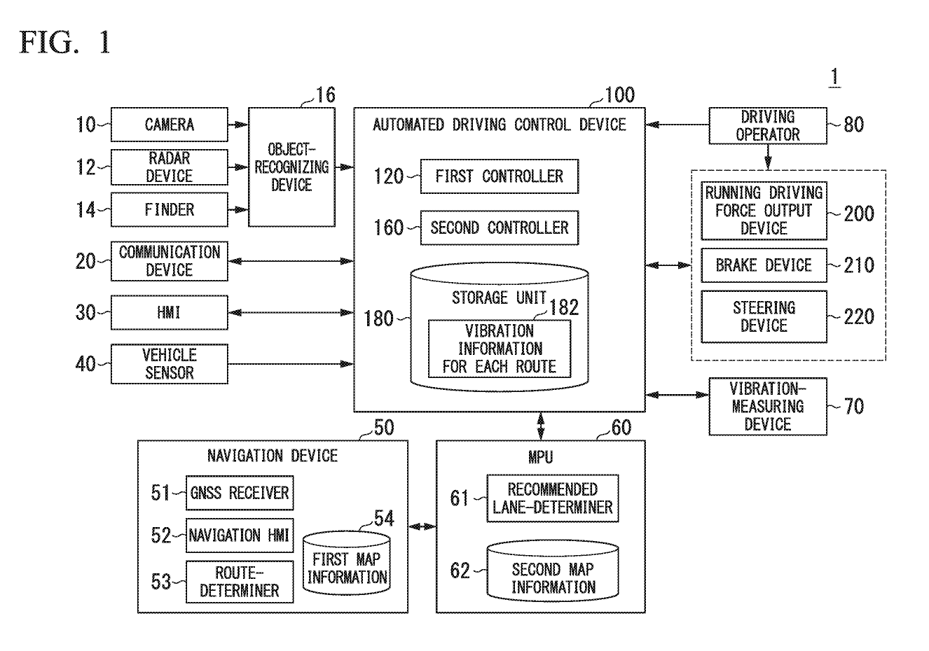

FIG. 1 is a configuration diagram of a vehicle system 1 using a vehicle control device according to a first embodiment. A vehicle in which the vehicle system 1 is mounted (hereinafter referred to as a subject vehicle M) is, for example, a vehicle having two wheels, three wheels, four wheels, or the like, and a driving source thereof is an internal combustion engine such as a diesel engine or a gasoline engine, an electric motor, or a combination thereof. In a case in which an electric motor is included, the electric motor operates using power generated using a power generator connected to an internal combustion engine or discharge power of a secondary cell or a fuel cell.

The vehicle system 1, for example, includes a camera 10, a radar device 12, a finder 14, an object-recognizing device 16, a communication device 20, a human machine interface (HMI) 30, a vehicle sensor 40, a navigation device 50, a map-positioning unit (MPU) 60, a vibration-measuring device 70, a driving operator 80, an automated driving control device 100, a running driving force output device 200, a brake device 210, and a steering device 220. These devices and units are interconnected using a multiplex communication line such as a controller area network (CAN) communication line, a serial communication line, a radio communication network, or the like. The configuration illustrated in FIG. 1 is merely one example, and parts of the configuration may be omitted or other components may be added.

The camera 10, for example, is a digital camera using a solid-state imaging device such as a charge-coupled device (CCD) or a complementary metal oxide semiconductor (CMOS). One or a plurality of cameras 10 are installed at arbitrary places on a vehicle in which the vehicle system 1 is mounted (hereinafter referred to as a subject vehicle M). In a case in which the area in front of the vehicle is to be imaged, the camera 10 is installed at an upper part of a front windshield, a rear face of a rearview mirror, or the like. The camera 10, for example, repeatedly images the vicinity of the subject vehicle M periodically. The camera 10 may be a stereo camera.

The radar device 12 emits radio waves such as millimeter waves to the vicinity of the subject vehicle M and detects at least a position of (a distance and an azimuth to) an object by detecting radio waves (reflected waves) reflected by the object. One or a plurality of radar devices 12 are installed at arbitrary places on the subject vehicle M. The radar device 12 may detect a position and a speed of an object using a frequency-modulated continuous wave (FM-CW) system.

The finder 14 is a light detection and ranging (LIDAR) device. The finder 14 emits light to the vicinity of the subject vehicle M and measures scattered light. The finder 14 detects a distance to a target on the basis of a time from light emission to light reception. The emitted light, for example, is pulse-form laser light. One or a plurality of finders 14 are mounted at arbitrary positions on the subject vehicle M.

The object-recognizing device 16 may perform a sensor fusion process on results of detection using some or all of the camera 10, the radar device 12, and the finder 14, thereby allowing recognition of a position, a type, a speed, and the like of an object. The object-recognizing device 16 outputs a result of recognition to the automated driving control device 100. In addition, when necessary, the object-recognizing device 16 may output results of detection using the camera 10, the radar device 12, and the finder 14 to the automated driving control device 100 as they are.

The communication device 20, for example, communicates with other vehicles in the vicinity of the subject vehicle M using a cellular network, a Wi-Fi network, Bluetooth (registered trademark), dedicated short range communication (DSRC), or the like or communicates with various server apparatuses through a radio base station. Another vehicle m, for example, similar to the subject vehicle M, may be either a vehicle performing automated driving or a vehicle performing manual driving, and there is no specific restriction. In the manual driving, unlike the automated driving described above, the acceleration/deceleration and the steering of the subject vehicle M are controlled in accordance with an operation performed by a vehicle occupant on the driving operator 80.

The HMI 30 presents various types of information to an occupant of the subject vehicle M and receives an input operation performed by a vehicle occupant. The HMI 30 may include various display devices, a speaker, a buzzer, a touch panel, switches, keys, and the like.

The vehicle sensor 40 includes a vehicle speed sensor that detects a speed of the subject vehicle M, an acceleration sensor that detects an acceleration, a yaw rate sensor (gyro sensor) that detects an angular velocity around a vertical axis, an azimuth sensor that detects the azimuth of the subject vehicle M, and the like. In addition, the vehicle sensor 40 may include a six-axis sensor including three acceleration sensors and three yaw rate sensors. For example, the six-axis sensor detects an acceleration and an angular velocity in a vertical direction, an acceleration and an angular velocity in the advancement direction of the subject vehicle M, and an acceleration and an angular velocity in the vehicle-width direction of the subject vehicle M. For example, an acceleration sensor that detects an acceleration in the vertical direction is disposed in a suspension.

The navigation device 50, for example, includes a global navigation satellite system (GNSS) receiver 51, a navigation HMI 52, and a route-determiner 53 and stores first map information 54 in a storage device such as a hard disk drive (HDD) or a flash memory. The GNSS receiver 51 identifies a position of a subject vehicle M on the basis of signals received from GNSS satellites. The position of the subject vehicle M may be identified or supplemented by an inertial navigation system (INS) using an output of the vehicle sensor 40. The navigation HMI 52 includes a display device, a speaker, a touch panel, a key, and the like. A part or all of the navigation HMI 52 and the HMI 30 described above may be configured to be shared. The route-determiner 53, for example, determines a route to a destination input by a vehicle occupant using the navigation HMI 52 (hereinafter referred to as a route on a map) from a position of the subject vehicle M identified by the GNSS receiver 51 (or an input arbitrary position) by referring to the first map information 54. The first map information 54, for example, is information in which a road form is represented by respective links representing a road and respective nodes connected using the links. The first map information 54 may include a curvature of each road, point of interest (POI) information, and the like. The route on the map determined by the route-determiner 53 is output to the MPU 60. In addition, the navigation device 50 may perform route guidance using the navigation HMI 52 on the basis of the route on the map determined by the route-determiner 53. Furthermore, the navigation device 50, for example, may be realized by a function of a terminal device such as a smartphone or a tablet terminal held by a vehicle occupant. In addition, the navigation device 50 may transmit a current location and a destination to a navigation server through the communication device 20 and acquire a route on the map received from the navigation server as a reply.

The MPU 60, for example, functions as a recommended lane-determiner 61 and stores second map information 62 in a storage device (storage) such as an HDD or a flash memory. The recommended lane-determiner 61 divides a route provided from the navigation device 50 into a plurality of blocks (for example, divides the route into blocks of 100 [m] in the advancement direction of the vehicle) and determines a recommended lane for each block by referring to the second map information 62. The recommended lane-determiner 61 determines a lane numbered from the left side in which to run. In a case in which a branching place, a merging place, or the like is present in the route, the recommended lane-determiner 61 determines a recommended lane such that the subject vehicle M can follow a reasonable route for advancement to divergent destinations.

The second map information 62 is map information having higher accuracy than the first map information 54. The second map information 62, for example, includes information of the center of each lane, information of a boundary between lanes, information representing the location (position) of a ground object, and the like. Here, a ground object, for example, may be either an object having a three-dimensional entity such as a road mark, a traffic signal, an electric post, a delineator, or a tree or an object having a two-dimensional entity such as a road marking drawn on a road surface such as a temporary stop line, a crosswalk, or a partition line, or the like. In addition, road information, traffic regulation information, address information (an address and a postal code), facility information, telephone number information, and the like may be included in the second map information 62. The second map information 62 may be updated when necessary by accessing another device using the communication device 20.

The vibration-measuring device 70, for example, repeatedly measures vibration in the vertical direction of the subject vehicle M at predetermined intervals. For example, the vibration-measuring device 70 performs second-order integration of an acceleration that is a value detected by an acceleration sensor disposed in the suspension and derives an integration value thereof as a displacement quantity of the vibration of the subject vehicle M in the vertical direction. In addition, the vibration-measuring device 70 may derive a displacement quantity of vibration of the subject vehicle M by performing second-order integration of an acceleration that is a value detected by an acceleration sensor disposed on the vehicle body side (for example, inside a cabin) supported by the suspension. In such a case, in order to eliminate the influence of vibration suppression using the suspension from a result of the measurement, the vibration-measuring device 70 may set a displacement acquired by subtracting a displacement of the vehicle from a relative displacement between the road surface and the vehicle body as vibration (road surface displacement) of the subject vehicle M. In addition, instead of deriving a displacement quantity of a vibration by performing a second-order differential of the acceleration in the vertical direction, the vibration-measuring device 70 may measure a distance between the subject vehicle M and the road surface using laser light, sonic waves, electric waves, or the like and derive the measured distance (displacement) as a displacement quantity of the vibration. Hereinafter, information of a trend of a vibration changing in accordance with the time or the distance will be referred to as “vibration data” in the description. The vibration-measuring device 70 is one example of a “measurement unit.”

The driving operator 80, for example, includes an acceleration pedal, a brake pedal, a shift lever, a steering wheel, a steering wheel variant, a joystick, and other operators. A sensor detecting the amount of an operation or the presence/absence of an operation is installed in the driving operator 80, and a result of the detection is output to the automated driving control device 100 or at least one or all of the running driving force output device 200, the brake device 210, and the steering device 220.

The automated driving control device 100, for example, includes a first controller 120, a second controller 160, and a storage unit (storage) 180. Constituent elements of the first controller 120 and second controller 160, for example, are realized by a processor such as a central processing unit (CPU) or a graphics processing unit (GPU) executing a program (software). In addition, some or all of these constituent elements may be realized by hardware (a circuit unit; including circuitry) such as a large-scale integration (LSI), an application specific integrated circuit (ASIC), or a field-programmable gate array (FPGA), or may be realized by software and hardware in cooperation. The program may be stored in a storage device such as a hard disk drive (HDD) or a flash memory in advance or may be stored in a storage medium such as a DVD or a CD-ROM that can be loaded or unloaded and installed in the storage unit 180 by loading the storage medium into a drive device of the automated driving control device 100.

The storage unit 180, for example, is realized by a hard disk drive (HDD), a flash memory, an electrically erasable programmable read-only memory (EEPROM), a read-only memory (ROM), a random-access memory (RAM), or the like. In the storage unit 180, in addition to a program read and executed by the processor, information such as vibration information 182 for each route is stored. The storage unit 180 is one example of a “predetermined storage unit.”

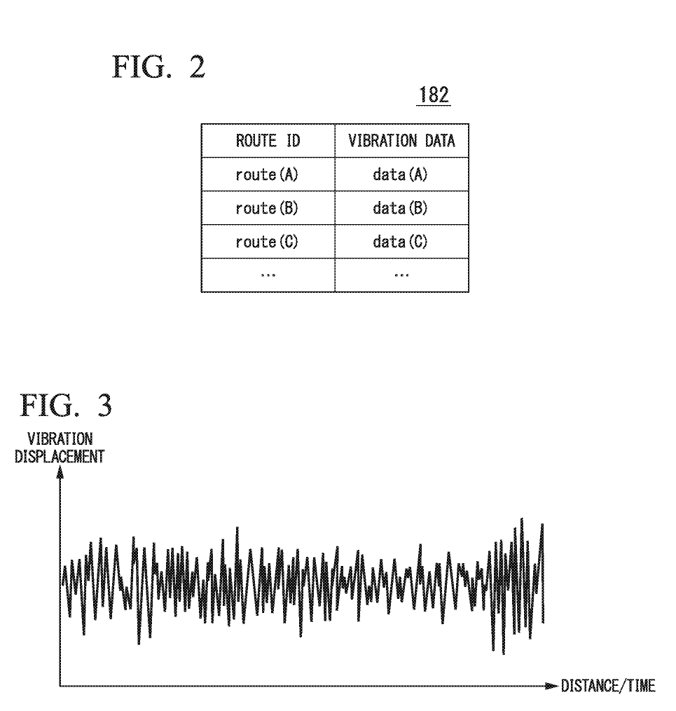

FIG. 2 is a diagram showing one example of the vibration information 182 for each route. For example, the vibration information 182 for each route is information in which vibration data representing a trend of vibration measured by a probe vehicle is associated with identification information of a route (a route ID in the drawing) that the probe vehicle has run. Here, the probe vehicle is a vehicle that includes the vibration-measuring device 70 or a device corresponding thereto. Accordingly, the probe vehicle may be either the subject vehicle M or another vehicle.

FIG. 3 is a diagram showing one example of vibration data. As illustrated in the drawing, the vibration data is data representing changes in the displacement of vibration according to a distance run by the probe vehicle or a time for which the probe vehicle has run.

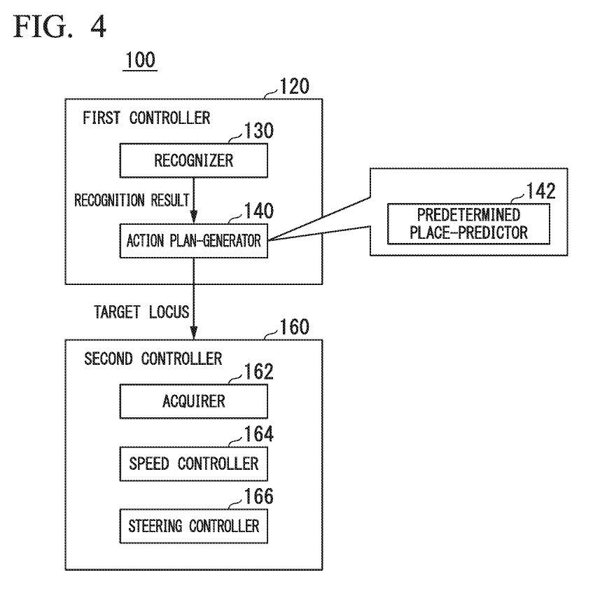

FIG. 4 is a functional configuration diagram of the first controller 120 and the second controller 160. The first controller 120, for example, includes a recognizer 130 and an action plan-generator 140. The action plan-generator 140, for example, includes a predetermined place-predictor 142. A combination of the action plan-generator 140 and the second controller 160 is one example of a “driving controller.”

The first controller 120, for example, simultaneously realizes functions using artificial intelligence (AI) and functions using a model provided in advance. For example, a function of “recognizing an intersection” may be realized by executing recognition of an intersection using deep learning or the like and recognition based on conditions given in advance (a signal, road markings, and the like that can be used for pattern matching are present) at the same time and comprehensively evaluating both recognitions by assigning scores to them. Accordingly, the reliability of automated driving is secured.

The recognizer 130 recognizes ground objects in the vicinity of the subject vehicle M on the basis of information input from the camera 10, the radar device 12, and the finder 14 through the object-recognizing device 16. In addition, the recognizer 130 may recognize other vehicles m as objects other than ground objects. Then, the recognizer 130 recognizes states of objects having entities such as ground objects, other vehicles m, and the like that have been recognized. Here, a “state” of an object, for example, includes a position, a speed, an acceleration, and the like. The position of an object, for example, is recognized as a position on an absolute coordinate system having a representative point (the center of gravity, the center of a driving shaft, or the like) of the subject vehicle M as its origin and is used for control. The position of an object may be represented as a representative point such as the center of gravity or a corner of an object or may be represented in a represented area. A “state” of an object may include an acceleration, a jerk, or an “action state” (for example, whether or not the object is changing or is about to change lanes) of an object. In addition, the recognizer 130 recognizes the shape of a curve along which the subject vehicle M will pass next on the basis of a captured image captured by the camera 10. The recognizer 130 converts the shape of the curve from the captured image captured by the camera 10 into an actual plane and, for example, outputs two-dimensional point sequence information or information represented using a model equivalent thereto to the action plan-generator 140 as information representing the shape of the curve.

In addition, the recognizer 130, for example, recognizes a lane in which the subject vehicle M is running (a running lane). For example, the recognizer 130 may recognize a running lane by comparing a pattern of road partition lines acquired from the second map information 62 (for example, an array of solid lines and broken lines) with a pattern of road partition lines in the vicinity of the subject vehicle M that has been recognized from an image captured by the camera 10. In addition, the recognizer 130 is not limited to recognizing road partition lines and may recognize a running lane by recognizing running lane boundaries (road boundaries) including a road partition line, a road shoulder, curbstones, a median strip, a guardrail, and the like. In the recognition, the position of the subject vehicle M acquired from the navigation device 50 or a result of the process executed by an INS may be additionally taken into account.

When a running lane is recognized, the recognizer 130 recognizes a position and a posture of the subject vehicle M with respect to the running lane. The recognizer 130, for example, may recognize a deviation of a reference point on the subject vehicle M from the center of the lane and an angle of the advancement direction of the subject vehicle M formed with respect to a line along the center of the lane as a relative position and a posture of the subject vehicle M with respect to the running lane. In addition, instead of this, the recognizer 130 may recognize a position of a reference point on the subject vehicle M with respect to a one side end part (a road partition line or a road boundary) of the running lane or the like as a relative position of the subject vehicle M with respect to the running lane.

In addition, the recognizer 130 recognizes a position of the subject vehicle M on the map represented by the second map information 62 on the basis of one or more ground objects that have been recognized. For example, the recognizer 130 performs three-point positioning on the basis of three ground objects having mutually different positions and derives a relative position of the subject vehicle M with respect to such ground objects. In addition, by converting the scale into the scale of the map with the relative distance with respect to the ground objects referred to when the three-point positioning is performed, the recognizer 130 specifies (determines) the position of the subject vehicle M on the map.

In addition, in the recognition process described above, the recognizer 130 derives a recognition accuracy and outputs the derived recognition accuracy to the action plan-generator 140 as recognition accuracy information. For example, the recognizer 130 generates recognition accuracy information on the basis of a frequency at which a road partition line is recognized over a predetermined time period.

The action plan-generator 140 determines events to be sequentially executed in automated driving such that the subject vehicle basically runs on a recommended lane determined by the recommended lane-determiner 61 and can respond to a surroundings status of the subject vehicle M. An event is information that defines a running mode of the subject vehicle M. As the events, for example, there are a constant-speed running event for running at a constant speed in the same running lane, a following running event of following a vehicle running ahead, an overtaking event of overtaking a vehicle running ahead, an avoidance event of performing braking and/or steering for avoiding approaching an obstacle object, a curved running event of running on a curve, a deceleration event of decelerating the subject vehicle M to a predetermined speed (for example, 0 [km/h] or several [km/h]) or less before a place such as an intersection, a crosswalk, or a railroad crossing, a lane change event, a merging event, a branching event, an automatic stopping event, a takeover event for ending automated driving and switching to manual driving, and the like. Here, “following,” for example, represents a mode in which the subject vehicle M runs with a relative distance (inter-vehicle distance) between the subject vehicle M and the preceding vehicle maintained to be constant. For example, for a place such as an intersection or a railroad crossing on the map represented by the second map information 62 at which temporary stop is necessary, the action plan-generator 140 plans a deceleration event from a predetermined distance before the place.

In a case in which the subject vehicle M arrives at a place, for which each event is planned, on the map represented by the second map information 62, the action plan-generator 140 starts an event corresponding to the place. Then, the action plan-generator 140 generates a target locus along which the subject vehicle M will run in the future in accordance with operating events. Details of each functional unit will be described later. The target locus, for example, includes a speed element. For example, the target locus is represented by sequentially aligning places (locus points) at which the subject vehicle M will arrive. A locus point is a place at which the subject vehicle M will arrive at respective predetermined running distances (for example, about every several [m]) as distances along the road, and separately, a target speed and a target acceleration for each of predetermined sampling times (for example, a fraction of a [sec]) are generated as a part of the target locus. In addition, a locus point may be a position at which the subject vehicle M will arrive at a sampling time for each predetermined sampling time. In such a case, information of a target speed or a target acceleration is represented using intervals between the locus points.

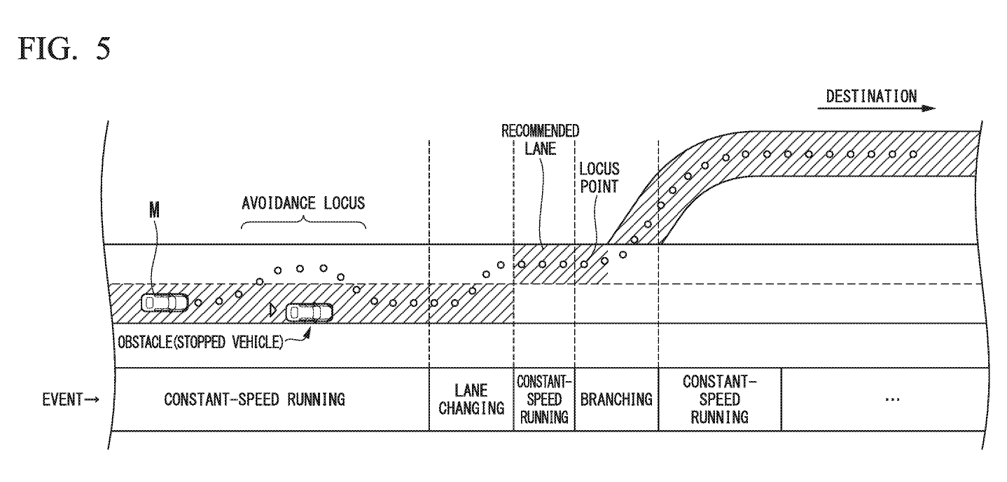

FIG. 5 is a diagram showing a view in which a target locus is generated on the basis of recommended lanes. As illustrated in the drawing, the recommended lanes are set such that surroundings are convenient for running along a route to a destination. When reaching a predetermined distance (may be determined in accordance with a type of event) before a place at which a recommended lane is changed, the action plan-generator 140 executes the passing through event, the lane change event, the branching event, the merging event, or the like. During execution of each event, in a case in which there is a need to avoid an obstacle object, an avoidance locus is generated as illustrated in the drawing.

The second controller 160 performs control of the running driving force output device 200, the brake device 210, and the steering device 220 such that the subject vehicle M passes along a target locus generated by the action plan-generator 140 at a scheduled time.

Referring back to FIG. 4, the second controller 160, for example, includes an acquirer 162, a speed controller 164, and a steering controller 166. The acquirer 162 acquires information of a target locus (locus points) generated by the action plan-generator 140 and stores the target locus information in a memory (not illustrated). The speed controller 164 controls the running driving force output device 200 or the brake device 210 on the basis of a speed element accompanying the target locus stored in the memory. The steering controller 166 controls the steering device 220 in accordance with a degree of curvature of the target locus stored in the memory. The processes of the speed controller 164 and the steering controller 166, for example, are realized by a combination of feed-forward control and feedback control. For example, the steering controller 166 may execute feed-forward control according to the curvature of a road in front of the subject vehicle M and feedback control based on a deviation from the target locus in combination.

The running driving force output device 200 outputs a running driving force (torque) used for a vehicle to run to driving wheels. The running driving force output device 200, for example, includes a combination of an internal combustion engine, an electric motor, a transmission, and the like and an ECU controlling these components. The ECU controls the components described above in accordance with information input from the second controller 160 or information input from the driving operator 80.

The brake device 210, for example, includes a brake caliper, a cylinder that delivers hydraulic pressure to the brake caliper, an electric motor that generates hydraulic pressure in the cylinder, and a brake ECU. The brake ECU performs control of the electric motor in accordance with information input from the second controller 160 or information input from the driving operator 80 such that a brake torque according to a brake operation is output to each vehicle wheel. The brake device 210 may include a mechanism delivering hydraulic pressure generated in accordance with an operation on the brake pedal included in the driving operators 80 to the cylinder through a master cylinder as a backup. In addition, the brake device 210 is not limited to the configuration described above and may be an electronically controlled hydraulic brake device that delivers hydraulic pressure in the master cylinder to a cylinder by controlling an actuator in accordance with information input from the second controller 160.

The steering device 220, for example, includes a steering ECU and an electric motor. The electric motor, for example, changes the direction of the steering wheel by applying a force to a rack and pinion mechanism. The steering ECU changes the direction of the steering wheel by driving an electric motor in accordance with information input from the second controller 160 or information input from the driving operator 80.

### Estimation of Own Position Based on Vibration at Time of Running on Route

Hereinafter, details of a process executed by the predetermined place-predictor 142 of the action plan-generator 140 will be described. The predetermined place-predictor 142 determines whether or not the number of ground objects present in front of the subject vehicle M in the advancement direction is less than a predetermined number (for example, about two or three) and, in a case in which it is determined that the number of ground objects is less than the predetermined number, predicts that a predetermined place is present in front of the subject vehicle M in the advancement direction on the basis of vibration data acquired from the vibration-measuring device 70. Here, a predetermined place is a place at which at least a speed state of the subject vehicle M needs to be changed and, for example, is an intersection. In addition, a predetermined place may be a place such as a railroad crossing, a crosswalk, or a school zone at which a speed regulation is set or any other place.

For example, the predetermined place-predictor 142 counts the number of ground objects present within a route that the subject vehicle M is planned to enter subsequently or in the vicinity of the route among one or more ground objects associated with positions in advance on the map represented by the second map information 62. In other words, the predetermined place-predictor 142 counts the number of ground objects present in front of the subject vehicle M in the advancement direction among one or more virtual (having no entity) ground objects associated with positions on the map.

In addition, the predetermined place-predictor 142 may count the number of ground objects present in front of the subject vehicle M in the advancement direction among one or more ground objects recognized by the recognizer 130. In other words, the predetermined place-predictor 142 counts the number of ground objects present in front of the subject vehicle M in the advancement direction among one or more objects having entities present in a three-dimensional space that is a detection area of various sensors.

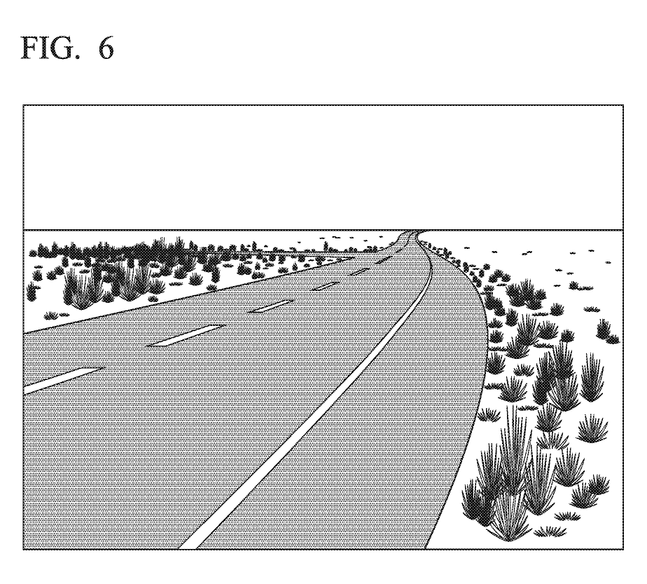

FIG. 6 is a diagram showing one example of a view in which no ground object is present. As in the example illustrated in the drawing, in a case in which the subject vehicle M travels not in a city street but a wilderness, a farm road, or the like, in the vicinity of a route, frequently, a ground object such as a road marking or the like is not present, or the number of ground objects is small. In a case in which a ground object is not present or in a case in which the number of ground objects is small, there are cases in which ground objects required for recognizing the position of the subject vehicle M on the map are not sufficient, and the accuracy of recognition of the position of the subject vehicle decreases. In such cases, it is assumed that the action plan-generator 140 may not recognize a place at which the subject vehicle M is present on the map with a high accuracy, and an event planned in advance may start at an incorrect timing. As a result, for example, in order to make a right turn or a left turn at an intersection, although a vehicle is originally supposed to decelerate a predetermined distance before the intersection, there is a possibility that the the vehicle arrives at the intersection without sufficiently decelerating.

Accordingly, in a case in which the number of counted ground objects is less than a predetermined number, and the accuracy of recognition of the position of the subject vehicle M is assumed to decrease in a case in which the subject vehicle runs along the route, the predetermined place-predictor 142 compares a trend of vibrations measured by a probe vehicle that runs along the route in the past with a trend of vibrations measured by the vibration-measuring device 70 at the time of running along the route and estimates a position of the vicinity in which the subject vehicle M is running along the route. Then, the predetermined place-predictor 142 predicts that a predetermined place is present in front of the subject vehicle M in the advancement direction on the basis of the position of the subject vehicle M specified on the map.

### Process Flow

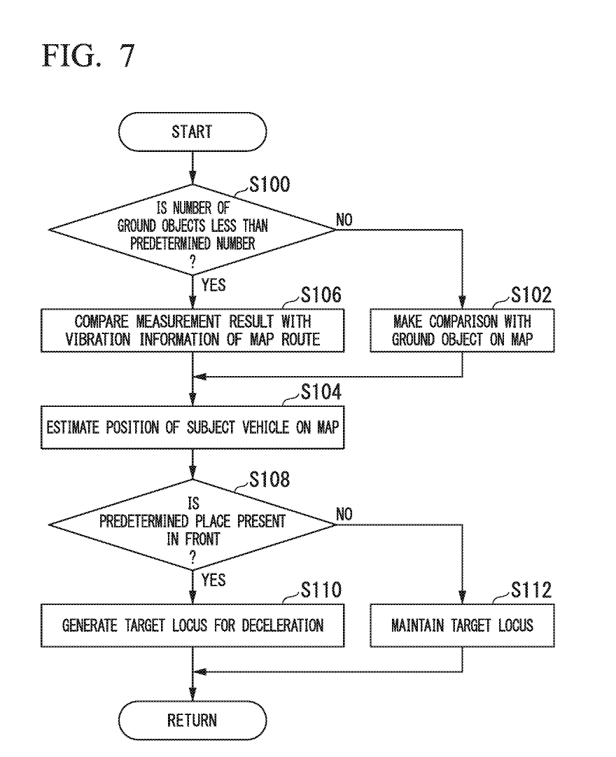

FIG. 7 is a flowchart showing one example of a process executed by the automated driving control device 100 according to the first embodiment. For example, when counting of the number of ground objects is started by the predetermined place-predictor 142, the process of this flowchart starts and, after the starting, may be repeatedly executed at predetermined intervals. In addition, separately from the process of this flowchart, a vibration-measuring process may be repeatedly performed by the vibration-measuring device 70.

First, the predetermined place-predictor 142 determines whether or not the counted number of ground objects is less than a predetermined number (Step S100). In a case in which the number of ground objects is determined to be equal to or greater than the predetermined number by the predetermined place-predictor 142, the recognizer 130 compares the recognized ground objects with ground objects on the map represented by the second map information 62 (Step S102) and estimates the position of the subject vehicle M on the map (Step S104).

On the other hand, in a case in which the number of ground objects is determined to be less than the predetermined number, the predetermined place-predictor 142 acquires vibration data that has been repeatedly measured by the vibration-measuring device 70 until a predetermined time elapses, compares this vibration data with vibration data associated with the same route as the route along which the subject vehicle M is running in the vibration information 182 for each route (Step S106), and estimates the position of the subject vehicle M on the map.

For example, the predetermined place-predictor 142 searches for a section in which vibration data measured by the vibration-measuring device 70 coincides with the vibration data included in the vibration information 182 for each route. As a result of the search, in a case in which a section in which the vibration data coincides with each other is present in the route, the predetermined place-predictor 142 estimates that the subject vehicle M is positioned in the section.

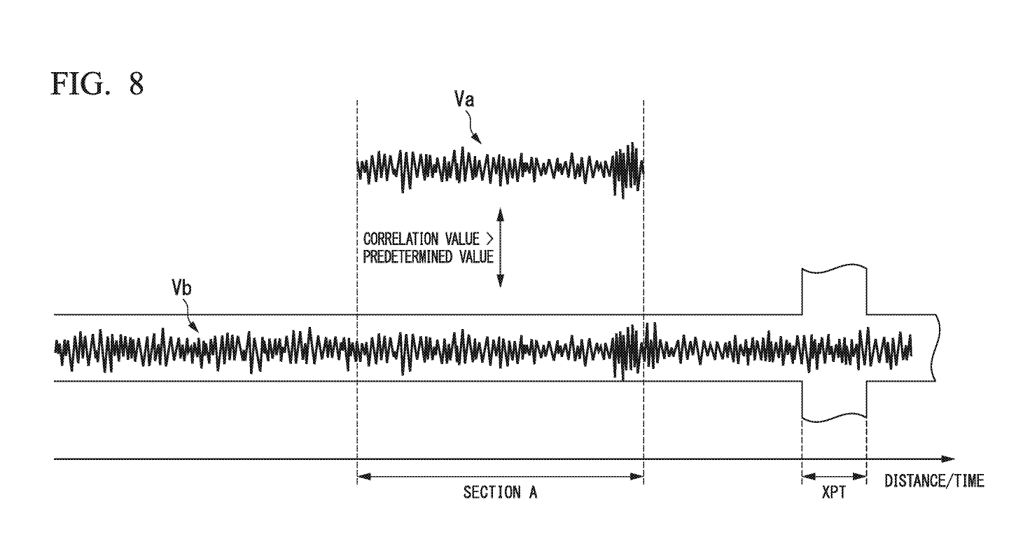

FIG. 8 is a diagram showing a method of estimating a position of a subject vehicle M on the basis of vibration data. In the drawing, vibration data Va represents vibration data measured by the vibration-measuring device 70, and vibration data Vb represents vibration data measured by a probe vehicle. As illustrated in the drawing, the vibration data Vb, for example, is data of a trend of vibrations measured over the entire area in the extending direction of a route. For this reason, while shifting the measured vibration data Va measured until a predetermined time elapses with respect to the vibration data Vb in the direction of a distance or a time, the predetermined place-predictor 142 acquires mutual correlation between both the vibration data and determines whether or not a section on the route in which a correlation value of such vibration data is equal to or greater than a predetermined value (for example, 0.5) is present. In the example illustrated in the drawing, in a section A, a correlation value is equal to or greater than a predetermined value. In this case, the predetermined place-predictor 142 estimates that the subject vehicle M is positioned in the section A.

In a case in which the position of the subject vehicle M on the map is estimated, the predetermined place-predictor 142 determines whether or not a predetermined place is present in front of the subject vehicle M in the advancement direction on the basis of the estimated position (Step S108). In the example illustrated in FIG. 8, an intersection XPT is present in front of the section A on the map. Accordingly, the predetermined place-predictor 142 determines that the predetermined place is present in front of the subject vehicle M in the advancement direction.

In a case in which it is determined that the predetermined place is present in front of the subject vehicle M in the advancement direction by the predetermined place-predictor 142, the action plan-generator 140 starts a deceleration event and generates a target locus including a target speed that is equal to or less than a predetermined speed as a speed element (Step S110). The speed controller 164 receives this and decelerates the subject vehicle M by controlling the running driving force output device 200 or the brake device 210 on the basis of the target speed included in the target locus as a speed element.

On the other hand, in a case in which it is determined that the predetermined place is not present in front of the subject vehicle M in the advancement direction by the predetermined place-predictor 142, the action plan-generator 140 continuously executes the event that is currently operating and maintains the current target locus without changing the target speed (Step S112). As a result, the subject vehicle M runs along the route in a state in which the speed is maintained.

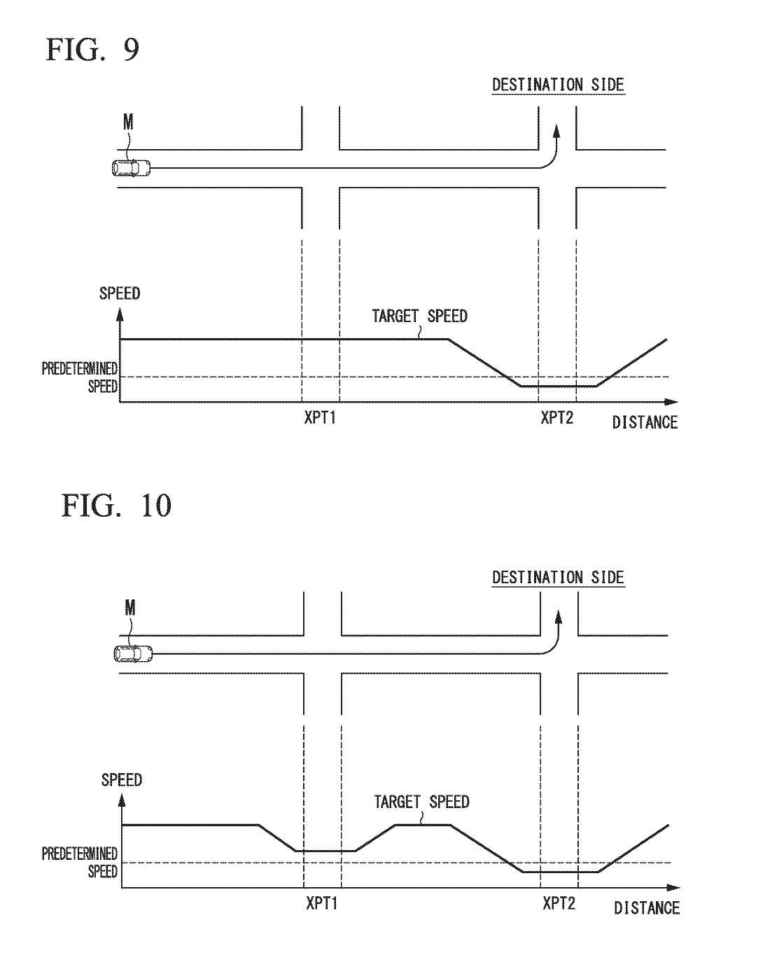

FIG. 9 is a diagram showing one example of a method of setting a target speed when a predetermined place is present. In the example illustrated in the drawing, a first intersection XPT1 and a second intersection XPT2 are present in front of the subject vehicle M on the map. An event of causing the subject vehicle M to make a left turn at the second intersection XPT2 that is positioned on a further rear side out of the two intersections is planned. In such a case, the action plan-generator 140 may generate a target locus in which the target speed of the subject vehicle M is not decreased to be equal to or less than a predetermined speed before the first intersection XPT1, and the target speed is decreased to be equal to or less than the predetermined speed before the second intersection XPT2. By generating such a target locus, the subject vehicle M can be decelerated before a place at which at least a left/right turn is necessary.

FIG. 10 is a diagram showing another example of a method of setting a target speed when a predetermined place is present. In the example illustrated in FIG. 10, similar to FIG. 9, a first intersection XPT1 and a second intersection XPT2 are present in front of the subject vehicle M on the map, and an event of causing the subject vehicle M to make a left turn at the second intersection XPT2 that is positioned on a further rear side out of the two intersections is planned. In this case, for example, the action plan-generator 140 may generate a target locus in which the target speed is decreased within a speed range lower than a target speed of the current state and higher than a predetermined speed before the first intersection XPT1, and the target speed is decreased to be equal to or less than the predetermined speed before the second intersection XPT2. By generating such a target locus, the subject vehicle M can be decelerated before the intersection XPT2 at which at least a left/right turn is necessary, and the subject vehicle M can be decelerated also at the intersection XPT1 at which there is a likelihood that another vehicle running in another lane enters the own lane.

In addition, in the embodiment described above, although the vibration information 182 for each route has been described as being stored in the storage unit 180 included in the automated driving control device 100, the storage thereof is not limited thereto, and, for example, the vibration information for each route may be stored in an external storage device on a network. In such a case, for example, any one constituent element of the first controller 120 (for example, the action plan-generator 140) may cause the communication device 20 to communicate with the external storage device and acquire the vibration information 182 for each route from the external storage device. The external storage device on a network is an example of a “predetermined storage unit.”

According to the first embodiment described above, by including the vibration-measuring device 70 that measures a vibration of the subject vehicle M and the predetermined place-predictor 142 that predicts the presence of a predetermined place in front of the subject vehicle M in the advancement direction on the basis of a degree of coincidence between vibration data measured by the vibration-measuring device 70 and vibration data measured by a probe vehicle, automated driving can be executed in more sections.

For example, in a case in which the position of the subject vehicle M is recognized on a map using a positioning system such as the GNSS, positional error of about 15 [m] tends to occur. In addition, a case in which the accuracy of the map is low and a case in which the amount of information included in a map is insufficient (information such as the number of lanes, a vehicle width, and the like may absent) may be assumed as well. In such a case, the accuracy of recognition of the position of the subject vehicle M on the map decreases.

In contrast to this, according to the first embodiment, in a case in which the number of ground objects is small, an approximate position on the route at which the subject vehicle M is running is identified on the basis of a trend of vibrations of a probe vehicle that already has run along the route along which the subject vehicle M will subsequently run, and accordingly, the position of the subject vehicle M can be recognized with a high accuracy even in a situation in which the number of ground objects is small, the accuracy of recognition of a relative position of the subject vehicle M with respect to ground objects is low, the positioning error according to the GNSS is large, and the amount of information of the map is insufficient. As a result, events included in an action plan can be executed as are planned, and accordingly, automated driving can be executed in more sections.

### Second Embodiment

Hereinafter, a second embodiment will be described. According to the second embodiment, the presence of a predetermined place in front of the subject vehicle M in the advancement direction is predicted on the basis of a history of past vibration data of the subject vehicle M, which is different from the first embodiment. Hereinafter, differences from the first embodiment will be focused on in the description, and description of functions and the like that are common to the first embodiment will not be presented.

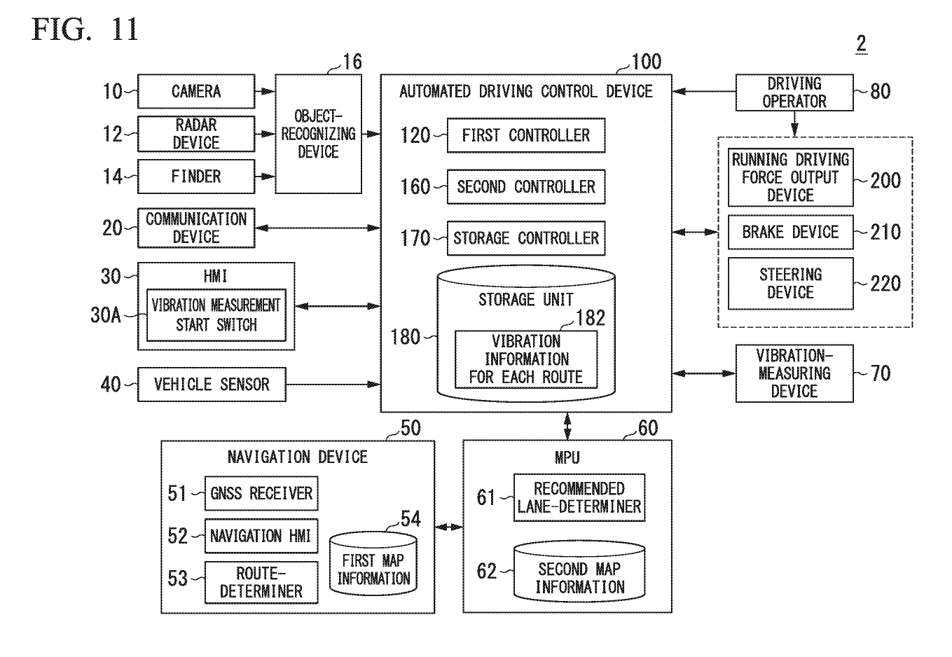

FIG. 11 is a configuration diagram of a vehicle system 2 using a vehicle control device according to the second embodiment. An HMI 30 according to the second embodiment, for example, includes a vibration measurement start switch 30A. The vibration measurement start switch 30A is a switch that is used for storing vibration data measured by a vibration-measuring device 70 in a storage device such as a storage unit 180 in association with a route along which the subject vehicle M runs. The vibration measurement start switch 30A is one example of an “acceptor.”

An automated driving control device 100 according to the second embodiment, for example, includes a first controller 120, a second controller 160, a storage controller 170, and a storage unit 180. Constituent elements of each of the first controller 120, the second controller 160, and the storage controller 170, for example, may be realized by a hardware processor such as a central processing unit (CPU) executing a program (software), hardware (a circuit unit; including a circuitry) such as an LSI, an ASIC, an FPGA, or a GPU, or cooperation between software or hardware.

For example, in a case in which the vibration measurement start switch 30A is operated by a vehicle occupant of the subject vehicle M, the storage controller 170 associates vibration data measured by the vibration-measuring device 70 with a route along which the subject vehicle M runs and stores the associated information in the storage unit 180 as new vibration information 182 for each new route. In addition, in a case in which the vibration information 182 for each route has already been stored in the storage unit 180, the storage controller 170 may add information associating the vibration data measured by the vibration-measuring device 70 and the route along which the subject vehicle M runs with each other to the vibration information 182 for each route.

Furthermore, instead of or in addition to the storing of the information associating vibration data and a route with each other in the storage unit 180 as the vibration information 182 for each route, the storage controller 170 may store the information in an external storage device. For example, the storage controller 170 may transmit the information associating vibration data and a route with each other to an external storage device by controlling the communication device 20 and store the information in the external storage device as the vibration information 182 for each route.

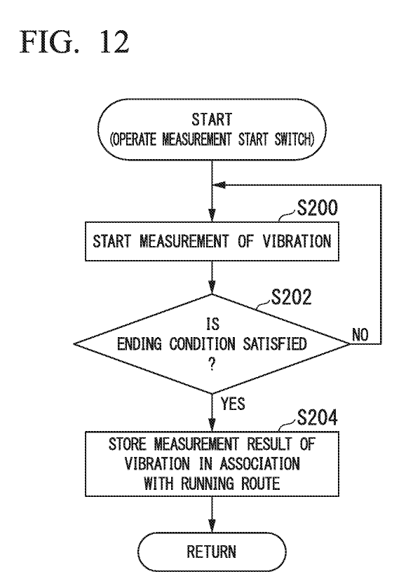

FIG. 12 is a flowchart showing one example of a process executed by the storage controller 170. The process of this flowchart, for example, starts when the vibration measurement start switch 30A is operated. Furthermore, in addition to or instead of the starting of the process of this flowchart under a condition that the vibration measurement start switch 30A is operated, the process may be started under a condition that a predetermined speech, a predetermined gesture, or the like is recognized.

First, the storage controller 170 causes the vibration-measuring device 70 to start measurement of vibrations of the subject vehicle M (Step S200) and, thereafter, determines whether a measurement ending condition is satisfied (Step S202). The measurement ending condition, for example, includes conditions such as a re-operation of the vibration measurement start switch 30A, recognition of a predetermined speech or a predetermined gesture, the elapse of a predetermined time after start of measurement, and running of the subject vehicle M over a predetermined distance after start of measurement.

In a case in which it is determined that the measurement ending condition is not satisfied, the storage controller 170 causes the vibration-measuring device 70 to continue the measurement. On the other hand, in a case in which it is determined that the measurement ending condition is satisfied, the storage controller 170 causes the vibration-measuring device 70 to end the measurement and stores the vibration data measured by the vibration-measuring device 70 in the storage unit 180 or an external storage device in association with the route along which the subject vehicle M runs (Step S204). In this way, the vibration data of the subject vehicle M is accumulated as a history.

Accordingly, in a case in which the number of ground objects present in front of the subject vehicle M in the advancement direction is less than a predetermined number, by comparing vibration data measured by the vibration-measuring device 70 at the current time point with vibration data measured by the vibration-measuring device 70 at a certain time point in the past, the predetermined place-predictor 142 specifies the position of the subject vehicle M on the map and predicts the presence of a predetermined place in front of the subject vehicle M in the advancement direction on the basis of the specified position.

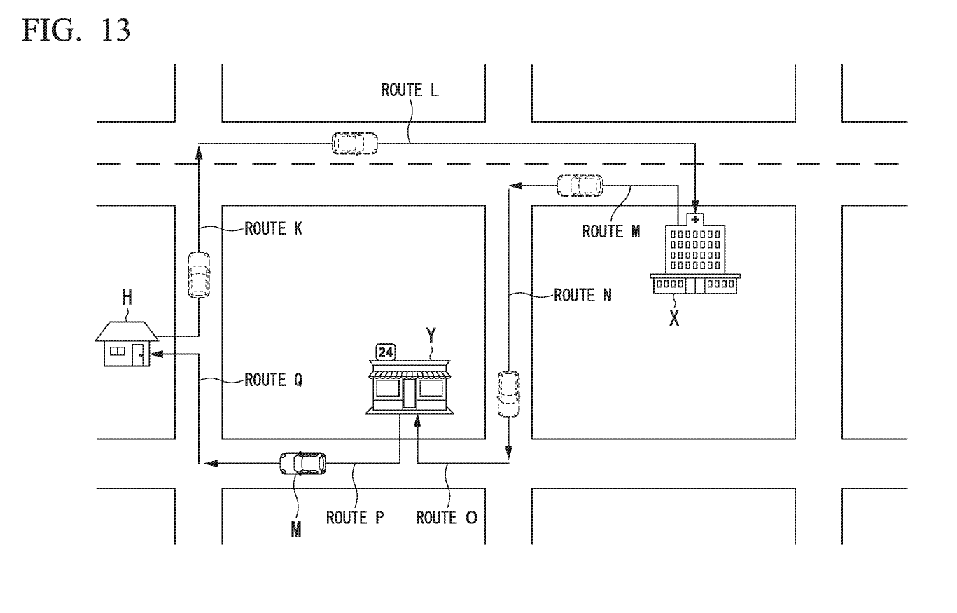

FIG. 13 is a diagram schematically illustrating a view in which vibration data of a subject vehicle M is accumulated. For example, it is assumed that a certain user manually drives the subject vehicle M, departs home H toward a hospital X, thereafter drops by a store Y such as a supermarket, and then returns to the home H. At this time, there are cases in which no ground object is present, or the number of ground objects is small in each route. In such cases, it is assumed that the user accumulates vibration data when the subject vehicle runs along each of routes K and L from the home H to the hospital X, routes M, N, and O from the hospital X to the store Y, and routes P and Q from the store Y to the home H by operating the vibration measurement start switch 30A. As a result, by collecting vibration data of routes along which the subject vehicle normally runs using manual driving, automated driving can be performed even in a section in which the number of ground objects is small, and it is difficult to execute automated driving. In other words, by user's collecting vibration data at an appropriate time during manual driving, even a section, in which manual driving is executed, that is routinely used can be set as a section in which automated driving can be executed.

### Hardware Configuration

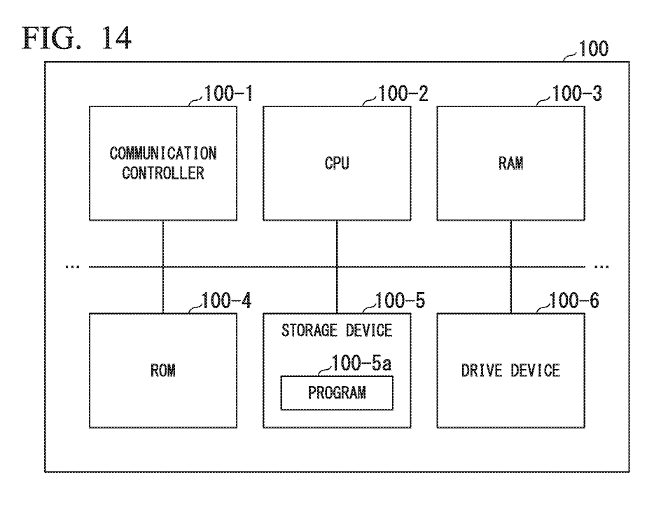

The automated driving control device 100 according to the embodiment described above, for example, is realized by a hardware configuration as illustrated in FIG. 14. FIG. 14 is a diagram showing one example of the hardware configuration of the automated driving control device 100 according to an embodiment.

The automated driving control device 100 has a configuration in which a communication controller 100-1, a CPU 100-2, a RAM 100-3, a ROM 100-4, a secondary storage device 100-5 such as a flash memory or an HDD, and a drive device 100-6 are interconnected through an internal bus or a dedicated communication line. A portable storage medium such as an optical disc is loaded into the drive device 100-6. A program 100-5a stored in the secondary storage device 100-5 is expanded into the RAM 100-3 by a DMA controller (not illustrated in the drawing) or the like and is executed by the CPU 100-2, whereby the first controller 120, the second controller 160, and the storage controller 170 are realized. In addition, the program referred to by the CPU 100-2 may be stored in the portable storage medium loaded into the drive device 100-6 or may be downloaded from another device through a network.

The embodiment described above may be represented as below.

A vehicle control device includes a measurement device that measures a vibration of a subject vehicle, a storage that stores a program, and a processor, the processor configured to predict the presence of a predetermined place, at which a control state of the subject vehicle is to be changed, in front of the subject vehicle in an advancement direction on the basis of a degree of coincidence between a trend of vibrations measured by the measurement unit and a vibration trend of a vehicle measured in advance by executing the program.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims. For example, the vehicle system 1 according to the embodiment described above may be applied to a system performing driving support such as ACC or LKAS.

What is claimed is:

1. A vehicle control device, comprising:
a measurement unit measuring vibration of a subject vehicle; and
a prediction unit predicting the presence of a predetermined place, at which a control state of the subject vehicle is to be changed in front of the subject vehicle in an advancement direction on the basis of a degree of coincidence between a trend of vibration measured by the measurement unit and a vibration trend of a vehicle measured in advance.

2. The vehicle control device according to claim 1, wherein the prediction unit predicts a fixed place of which a relative position with respect to a vehicle is not changed as the predetermined place.

3. The vehicle control device according to claim 1, further comprising:
a recognizer recognizing ground objects in the vicinity of the subject vehicle; and
a storage unit storing a map including positional information of ground objects that are recognizable for the recognizer,
wherein, in a case in which the number of ground objects present in front of the subject vehicle in the advancement direction on the map stored by the storage unit is less than a predetermined number, the prediction unit starts a process of predicting the presence of the predetermined place.

4. The vehicle control device according to claim 3, further comprising:
a driving controller that controls one or both of steering and acceleration/deceleration of the subject vehicle on the basis of a result of the prediction executed by the prediction unit in a case in which the number of ground objects present in front of the subject vehicle in the advancement direction among one or more ground objects with which positions are associated on the map is less than a predetermined number and controls one or both of the steering and the acceleration/deceleration of the subject vehicle on the basis of the ground objects recognized by the recognizer in a case in which the number of the ground objects is equal to or greater than the predetermined number.

5. The vehicle control device according to claim 1, further comprising:
an acceptor accepting an operation of a vehicle occupant of the subject vehicle; and
a storage controller storing information associating a trend of vibration measured by the measurement unit with a route along which the subject vehicle runs in a predetermined storage unit in a case in which a predetermined operation is accepted by the acceptor,
wherein the prediction unit selects information representing a trend of vibration of the subject vehicle acquired when the subject vehicle has run along a target route along which the subject vehicle is currently running in the past among one or more pieces of information stored in the storage unit and predicts the presence of the predetermined place in front of the subject vehicle in the advancement direction on the basis of the trend of the vibrations represented by the selected information and a trend of vibrations measured by the measurement unit while the vehicle is running along the target route.

6. A vehicle control method, comprising:
measuring vibration of a subject vehicle using a measurement unit; and
predicting the presence of a predetermined place at which a control state of the subject vehicle is to be changed in front of the subject vehicle in an advancement direction on the basis of a degree of coincidence between a trend of vibration measured by the measurement unit and a vibration trend of a vehicle measured in advance using a prediction unit.

7. A non-transitory computer-readable storage medium storing a program thereon, the program causing a computer, which is mounted in a vehicle including a measurement unit measuring vibration of a subject vehicle, to execute:
predicting the presence of a predetermined place at which a control state of the subject vehicle is to be changed in front of the subject vehicle in an advancement direction on the basis of a degree of coincidence between a trend of vibration measured by the measurement unit and a vibration trend of a vehicle measured in advance.
